(19) United States
(12) Patent Application Publication
(10) Pub. No.: US 2026/0292851 A1
(43) Pub. Date: Sep. 24, 2026

(54) TECHNIQUES FOR PRIORITIZATION FOR SIDELINK SYNCHRONIZATION SIGNAL BLOCKS

(71) Applicant: QUALCOMM Incorporated, San Diego, CA (US)

(72) Inventors: Siyi CHEN, Beijing (CN); Jing SUN, San Diego, CA (US); Xiaoxia ZHANG, San Diego, CA (US); Chih-Hao LIU, San Diego, CA (US); Changlong XU, Beijing (CN); Shaozhen GUO, Beijing (CN); Luanxia YANG, Beijing (CN); Hao XU, Beijing (CN)

(21) Appl. No.: 19/469,155

(22) PCT Filed: May 18, 2023
(86) PCT No.: PCT/CN2023/094931

§ 371 Date: Sep. 25, 2025

(51) Int. Cl. H04W 72/25; H04W 56/00; H04W 72/566

(52) U.S. Cl. CPC H04W 72/25; H04W 56/001; H04W 72/566

(57) ABSTRACT

Various aspects of the present disclosure generally relate to wireless communication. In some aspects, a user equipment (UE) may receive a configuration associated with transmitting a sidelink synchronization signal block (S-SSB), wherein the configuration indicates a first S-SSB occasion and a set of second S-SSB occasions, and wherein the set of second S-SSB occasions are included in a sidelink resource pool of the UE. The UE may receive priority information indicating one or more transmission priorities for the set of second S-SSB occasions. The UE may perform a communication in association with the set of second S-SSB occasions in accordance with the priority information. Numerous other aspects are described.

### FIELD OF THE DISCLOSURE

Aspects of the present disclosure generally relate to wireless communication and to techniques and apparatuses for prioritization for sidelink synchronization signal blocks.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include receiving a configuration associated with transmitting a sidelink synchronization signal block (S-SSB), wherein the configuration indicates a first S-SSB occasion and a set of second S-SSB occasions, and wherein the set of second S-SSB occasions are included in a sidelink resource pool of the UE. The method may include receiving priority information indicating one or more transmission priorities for the set of second S-SSB occasions. The method may include performing a communication in association with the set of second S-SSB occasions in accordance with the priority information.

Some aspects described herein relate to a UE for wireless communication. The UE may include one or more memories and one or more processors coupled to the one or more memories. The one or more processors may be configured to receive a configuration associated with transmitting an S-SSB, wherein the configuration indicates a first S-SSB occasion and a set of second S-SSB occasions, and wherein the set of second S-SSB occasions are included in a sidelink resource pool of the UE. The one or more processors may be configured to receive priority information indicating one or more transmission priorities for the set of second S-SSB occasions. The one or more processors may be configured to perform a communication in association with the set of second S-SSB occasions in accordance with the priority information.

Some aspects described herein relate to a non-transitory computer-readable medium that stores a set of instructions for wireless communication by a UE. The set of instructions, when executed by one or more processors of the UE, may cause the UE to receive a configuration associated with transmitting an S-SSB, wherein the configuration indicates a first S-SSB occasion and a set of second S-SSB occasions, and wherein the set of second S-SSB occasions are included in a sidelink resource pool of the UE. The set of instructions, when executed by one or more processors of the UE, may cause the UE to receive priority information indicating one or more transmission priorities for the set of second S-SSB occasions. The set of instructions, when executed by one or more processors of the UE, may cause the UE to perform a communication in association with the set of second S-SSB occasions in accordance with the priority information.

Some aspects described herein relate to an apparatus for wireless communication. The apparatus may include means for receiving a configuration associated with transmitting an S-SSB, wherein the configuration indicates a first S-SSB occasion and a set of second S-SSB occasions, and wherein the set of second S-SSB occasions are included in a sidelink resource pool of the apparatus. The apparatus may include means for receiving priority information indicating one or more transmission priorities for the set of second S-SSB occasions. The apparatus may include means for performing a communication in association with the set of second S-SSB occasions in accordance with the priority information.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIGS. 6-8 are diagrams illustrating examples of signaling associated with prioritization for sidelink synchronization signal blocks, in accordance with the present disclosure.

FIG. 9 is a diagram illustrating an example of prioritization among sidelink synchronization signal blocks according to synchronization priorities, in accordance with the present disclosure.

FIG. 10 is a diagram illustrating an example process performed, for example, by a UE, in accordance with the present disclosure.

FIG. 11 is a diagram of an example apparatus for wireless communication, in accordance with the present disclosure.

### DETAILED DESCRIPTION

Sidelink communication involves communication between multiple user equipments (UEs) without such communications passing via an intermediary such as a base station. In some aspects, a first UE may transmit a sidelink synchronization signal block (SSB). The sidelink SSB may be used to synchronize with the first UE. In some examples, the first UE may serve as a synchronization reference for a second UE, meaning that the second UE may synchronize according to a time reference and/or frequency reference derived from the sidelink SSB transmitted by the first UE. Sidelink SSBs may be transmitted periodically within a sidelink bandwidth part on resources (e.g., slots) that are not part of a sidelink resource pool. The location of a sidelink SSB (referred to as an S-SSB occasion) may be configured (e.g., pre-configured) within a sidelink bandwidth part. The first UE may also be associated with one or more additional candidate S-SSB occasions, referred to herein as second S-SSB occasions. A second S-SSB occasion is a resource on which an S-SSB may, or may not, be transmitted. For example, second S-SSB occasions may provide additional occasions for S-SSB transmission, which may allow for prioritization of traffic and recovery from failure to obtain channel access for S-SSB transmission. In some aspects, one or more second S-SSB occasions are excluded from a sidelink resource pool of the first UE. In some other aspects, one or more S-SSB occasions are included in (e.g., belong to) the sidelink resource pool of the first UE.

In some examples, a UE may communicate in unlicensed spectrum. Unlicensed spectrum typically involves a decentralized channel access mechanism, such as a listen-before-talk (LBT) mechanism, to access the channel (e.g., resources on the channel) and communicate with other UEs. A length of time during which a UE obtains access to the channel may be referred to as a channel occupancy time (COT). The UE may be permitted to transmit communications during the COT, and in some examples can share the COT with other wireless communication devices. One example of a radio access technology for communication in unlicensed spectrum is New Radio (NR) Unlicensed (NR-U).

In some deployments, if a COT is interrupted for a threshold length of time (for example, if the UE does not transmit any communications in the COT for the threshold length of time), then the UE's COT may end, and other UEs may obtain channel access. The UE may transmit communications during a COT on a sidelink resource pool of the UE. Therefore, it may be beneficial to include second S-SSB occasions in the sidelink resource pool, such that second S-SSB transmission on the second S-SSB occasions can assist in maintaining access to the UE's COT. However, the UE's sidelink resource pool can also be used for other transmissions or receptions, such as physical sidelink control channel (PSCCH) transmission or reception or physical sidelink shared channel (PSSCH) transmission or reception. Without rules for prioritizing transmission of S-SSBs on second S-SSB occasions versus other communications overlapping with the second S-SSB occasions, sidelink synchronization may be negatively impacted and throughput may be decreased. Furthermore, in some examples, a second S-SSB transmission of one UE may overlap with an S-SSB transmission of another UE. Without rules for prioritizing transmission and reception of S-SSBs when a second S-SSB transmission overlaps with reception of another S-SSB, UEs may fail to efficiently synchronize on the sidelink, which may be particularly impactful when out of radio access network coverage.

Various aspects relate generally to prioritization of sidelink communications. Some aspects more specifically relate to prioritization between second S-SSB occasions and other communications in a sidelink resource pool. In some examples, the UE may receive a configuration indicating a first S-SSB occasion and a set of second S-SSB occasions (e.g., additional candidate S-SSB occasions). The UE may also receive priority information that indicates one or more transmission priorities for the set of second S-SSB occasions. The UE may perform a communication (which may include an S-SSB transmission on a second S-SSB occasion, or transmission or reception of another communication) in association with the set of second S-SSB occasions in accordance with the priority information. In some examples, the UE may transmit an S-SSB on a second S-SSB occasion based at least in part on comparing a priority value of a received S-SSB and the transmission priority of the S-SSB on the second S-SSB occasion. For example, the transmission priority associated with the received S-SSB may be based at least in part on a synchronization priority of the received S-SSB. Thus, efficiency of sidelink synchronization is improved, particularly when out of radio access network coverage.

Particular aspects of the subject matter described in this disclosure can be implemented to realize one or more of the following potential advantages. In some examples, by performing a communication (which may include an S-SSB transmission on a second S-SSB occasion, or transmission or reception of another communication) in association with the set of second S-SSB occasions in accordance with the priority information, the described techniques can be used to improve sidelink synchronization and increase throughput. By transmitting an S-SSB on a second S-SSB occasion based at least in part on comparing a priority value of a received S-SSB and the transmission priority of the S-SSB on the second S-SSB occasion, efficiency of sidelink synchronization is improved, particularly when out of radio access network coverage.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

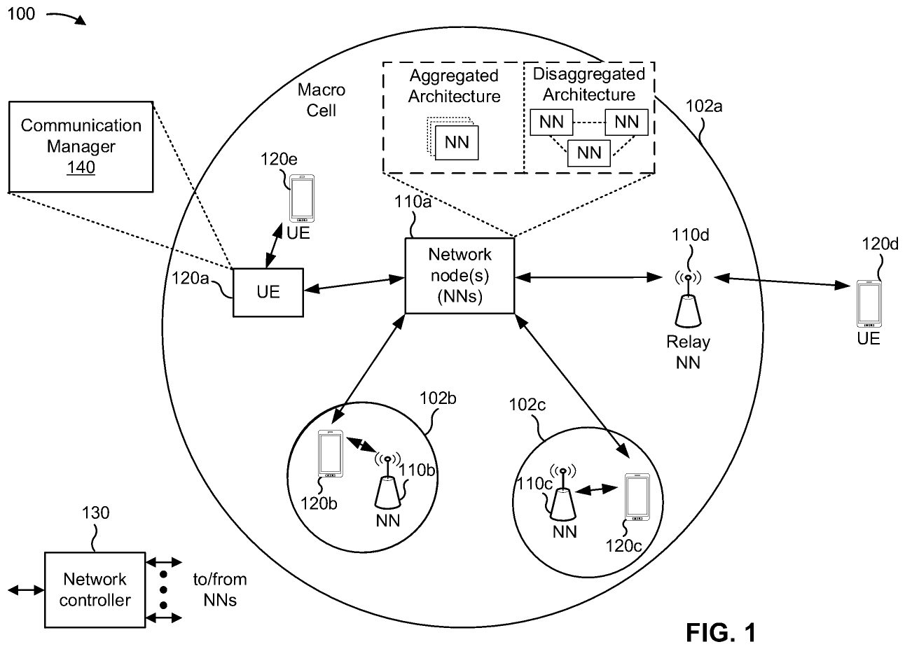

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHz), and FR5 (114.25 GHZ-300 GHz). Each of these higher frequency bands falls within the EHF band.

With these examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive a configuration associated with transmitting an S-SSB, wherein the configuration indicates a first S-SSB occasion and a set of second S-SSB occasions, and wherein the set of second S-SSB occasions are included in a sidelink resource pool of the UE 120; receive priority information indicating one or more transmission priorities for the set of second S-SSB occasions; and perform a communication in association with the set of second S-SSB occasions in accordance with the priority information. Additionally, or alternatively, the communication manager 140 may perform one or more other operations described herein.

As indicated above, FIG. 1 is provided as an example. Other examples may differ from what is described with regard to FIG. 1.

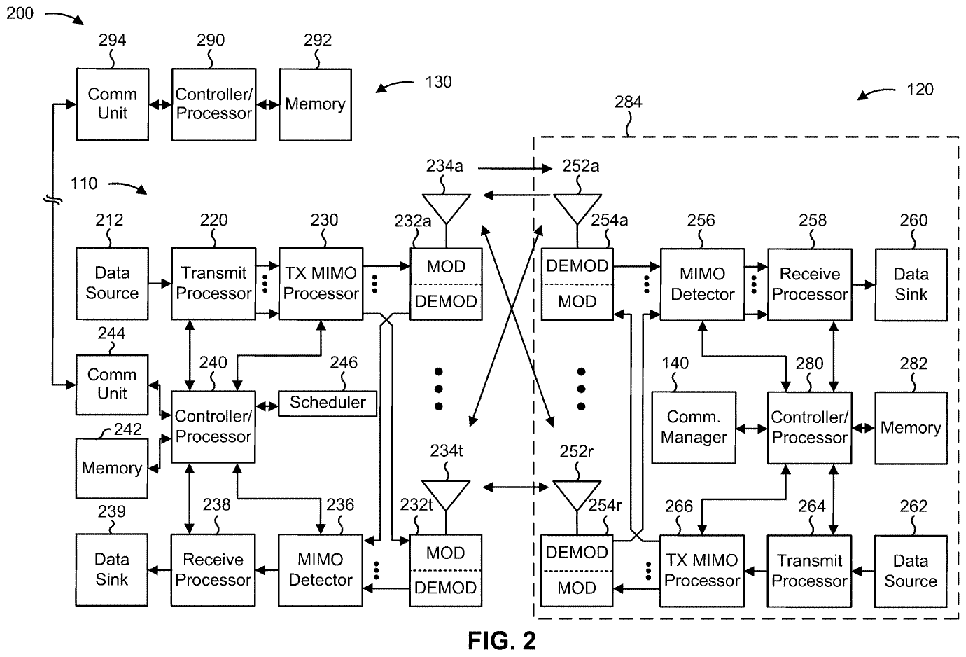

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

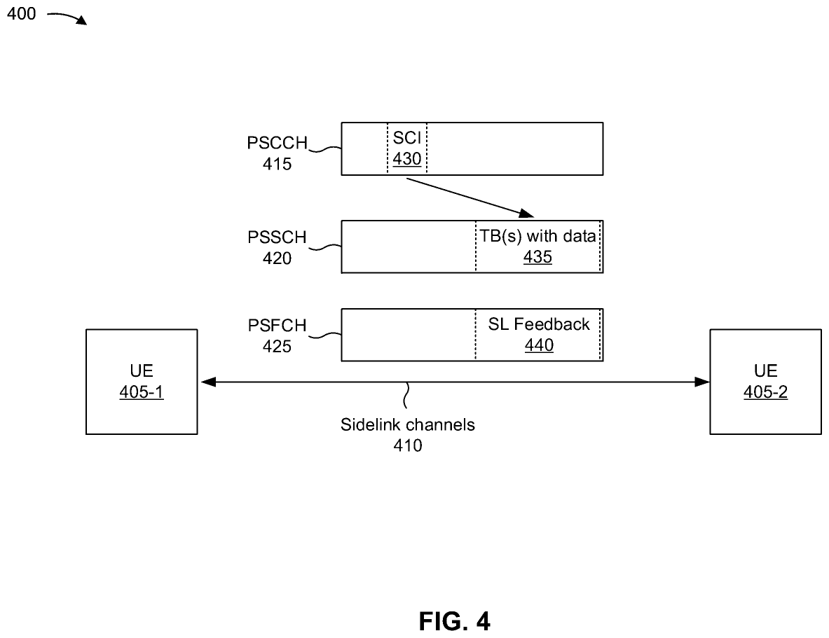

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-12).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 4-12).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

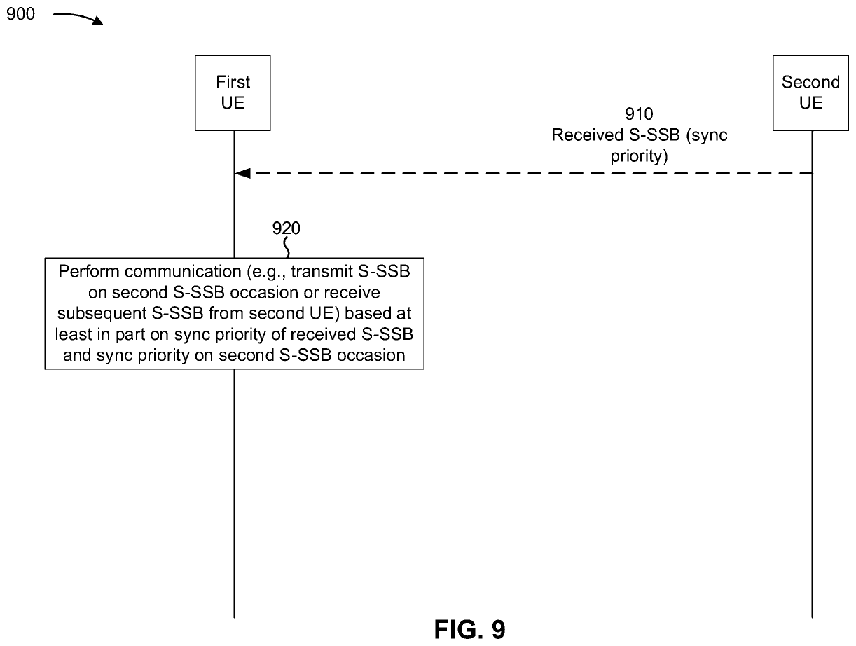

The controller/processor 240 of the network node 110, the controller/processor 280 of the UE 120, or any other component(s) of FIG. 2 may perform one or more techniques associated with sidelink synchronization, as described in more detail elsewhere herein. For example, the controller/processor 240 of the network node 110, the controller/processor 280 of the UE 120, or any other component(s) (or combinations of components) of FIG. 2 may perform or direct operations of, for example, process 900 of FIG. 9 and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 900 of FIG. 9 and/or other processes as described herein. In some examples, executing instructions may include running the instructions, converting the instructions, compiling the instructions, and/or interpreting the instructions, among other examples.

In some aspects, the UE 120 includes means for receiving a configuration associated with transmitting an S-SSB, wherein the configuration indicates a first S-SSB occasion and a set of second S-SSB occasions, and wherein the set of second S-SSB occasions are included in a sidelink resource pool of the UE 120; means for receiving priority information indicating one or more transmission priorities for the set of second S-SSB occasions; and/or means for performing a communication in association with the set of second S-SSB occasions in accordance with the priority information. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

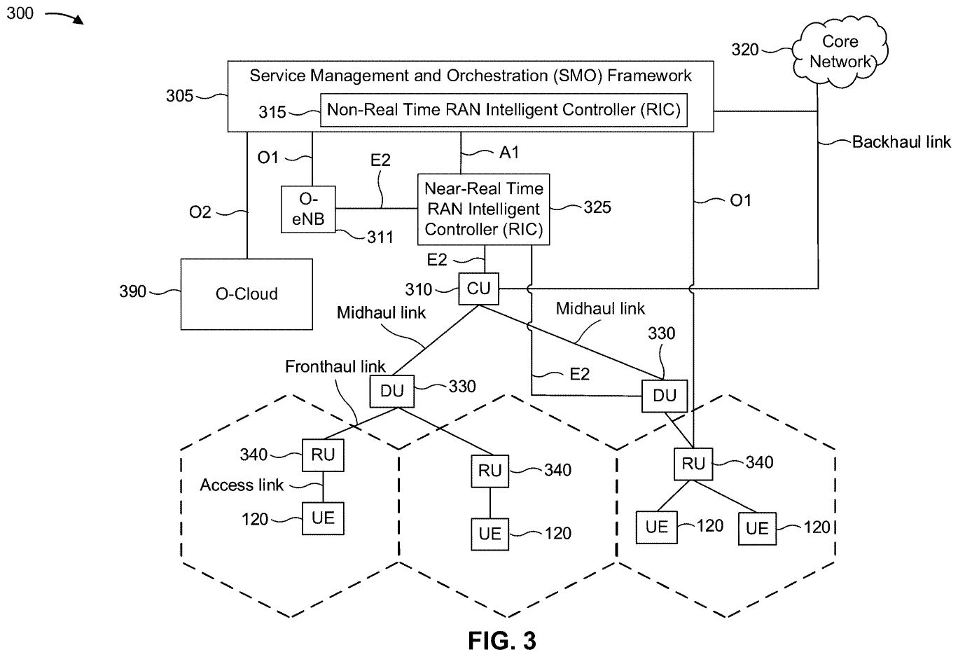

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 420, such as a hybrid automatic repeat request (HARQ) process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or a modulation and coding scheme (MCS) to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

In some aspects, a first UE 405 may transmit a sidelink synchronization signal block (SSB). “Sidelink SSB” is sometimes abbreviated as “S-SSB.” For example, the first UE 405 may transmit the sidelink SSB to a second UE 405. The sidelink SSB may include a physical sidelink broadcast channel (PSBCH), which may carry information supporting synchronization in the sidelink. The sidelink SSB may also include a sidelink primary synchronization signal (S-PSS) and a sidelink secondary synchronization signal (S-SSS), which the second UE 405 may use to synchronize with the first UE 405. In some examples, the first UE 405 may serve as a synchronization reference for the second UE 405, meaning that the second UE 405 may synchronize according to a time reference and/or frequency reference derived from the sidelink SSB transmitted by the first UE 405. Sidelink SSBs may be transmitted periodically within a sidelink bandwidth part on resources (e.g., slots) that are not part of a sidelink resource pool. The location of a sidelink SSB may be configured (e.g., pre-configured) within a sidelink bandwidth part.

The first UE 405 may be associated with a synchronization priority. A synchronization priority is a value used to determine whether a UE 405 receiving a sidelink SSB should synchronize according to the sidelink SSB. A synchronization priority may include a value that indicates a priority. A lower synchronization priority may correspond to a higher priority for synchronization. For example, an S-SSB having a synchronization priority of “P0” (e.g., a lowest possible synchronization priority) may be prioritized for synchronization over an S-SSB having a synchronization priority of “1” or greater. For example, if the receiving UE 405 is associated with a lower synchronization priority than the sidelink SSB, the receiving UE 405 may not synchronize using the sidelink SSB. If the receiving UE 405 is associated with a higher synchronization priority than the sidelink SSB, then the receiving UE 405 may synchronize using the sidelink SSB. The synchronization priority of a detected sidelink SSB may be determined from a sidelink synchronization signal (SLSS) identifier of the sidelink SSB, and from a coverage status indication in the PSBCH. The SLSS identifier and the coverage status indication may together indicate the synchronization priority of a detected S-SSB. Synchronization can include GNSS-based synchronization, in which the first UE 405 is synchronized to time or frequency information derived from a GNSS module of the UE, or network-based synchronization, in which the first UE 405 is synchronized to time or frequency information derived from a network node (e.g., a gNB or an eNB). It should be noted that, in some contexts, “synchronization priority” may be distinct from “transmission priority,” which is a priority value used to determine whether or not a given communication should be transmitted or received over another communication. For example, when the first UE 405 is prioritizing between an S-SSB transmission and a PSSCH transmission, the transmission priority may be distinct from the synchronization priority, and in some examples may include 8 possible priority values. When prioritizing whether to transmit a first S-SSB or receive a second S-SSB, the synchronization priority may be the same as the transmission priority. For example, the first UE 405 may use a first synchronization priority of an S-SSB to be transmitted by the first UE 405, and a second synchronization priority of an S-SSB to be received by the first UE 405, to determine whether to transmit the S-SSB or receive the S-SSB.

An S-SSB that is transmitted within a sidelink bandwidth part according to a configuration (e.g., a pre-configuration) may be referred to as a first S-SSB. For example, the first S-SSB may be transmitted on a resource defined by the configuration, wherein the resource is referred to as a first S-SSB occasion. There can be multiple first S-SSB occasions within an S-SSB period defined by the configuration. The multiple first S-SSB occasions may be distributed in time.

The first UE 405 may also be associated with one or more additional candidate S-SSB occasions, referred to herein as second S-SSB occasions. A second S-SSB occasion is a resource on which an S-SSB may, or may not, be transmitted. For example, second S-SSB occasions may provide additional occasions for S-SSB transmission, which may allow for prioritization of traffic and recovery from failure to obtain channel access for S-SSB transmission. In some aspects, one or more second S-SSB occasions are excluded from a sidelink resource pool of the first UE 405. In some other aspects, one or more S-SSB occasions are included in (e.g., belong to) the sidelink resource pool of the first UE 405.

In some aspects, one or more second S-SSB occasions may be indicated via a parameter, such as sl-NumSSB-WithinPeriod for each subcarrier spacing (SCS). For example, a range of available values of the parameter may be configured such that the parameter can be used to indicate second S-SSB occasions. In some other aspects, a sidelink S-SSB slot (including a first S-SSB occasion) may be associated with (e.g., have) K corresponding second S-SSB occasions, and the gap between the sidelink S-SSB slot and the K corresponding second S-SSB occasions may be configured (e.g., pre-configured). In some aspects, the number and location(s) of one or more second S-SSB occasions may be separately configured (e.g., pre-configured) via RRC signaling (e.g., separately from configuration of the first S-SSB occasions). In some aspects, an S-SSB period may include a number of contiguous second S-SSB occasions. In some aspects, the number of second S-SSB occasions may be configured (e.g., pre-configured), and locations may be determined based on the number of second S-SSB occasions.

As indicated above, FIG. 4 is provided as an example. Other examples may differ from what is described with respect to FIG. 4.

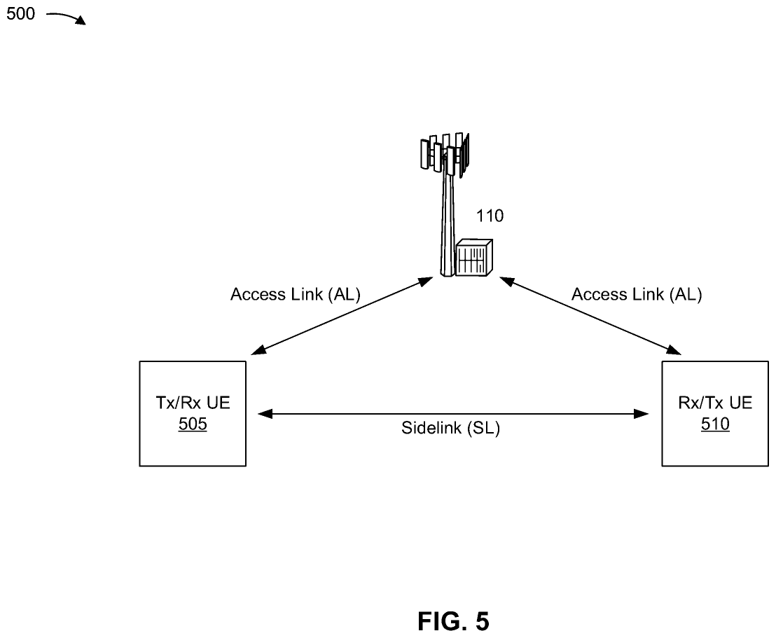

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 5 is provided as an example. Other examples may differ from what is described with respect to FIG. 5.

In some examples, a UE may communicate in unlicensed spectrum. Unlicensed spectrum typically involves a decentralized channel access mechanism, such as a listen-before-talk (LBT) mechanism, to access the channel (e.g., resources on the channel) and communicate with other UEs. A length of time during which a UE obtains access to the channel may be referred to as a channel occupancy time (COT). The UE may be permitted to transmit communications during the COT, and in some examples can share the COT with other wireless communication devices. One example of a radio access technology for communication in unlicensed spectrum is NR Unlicensed (NR-U).

In some deployments, if a COT is unused for a threshold length of time (for example, if the UE does not transmit any communications in the COT for the threshold length of time), then the UE's COT may end, and other UEs may obtain channel access. The UE may transmit communications during a COT on a sidelink resource pool of the UE. Therefore, it may be beneficial to include second S-SSB occasions in the sidelink resource pool, such that second S-SSB transmission on the second S-SSB occasions can assist in maintaining access to the UE's COT. However, the UE's sidelink resource pool can also be used for other transmissions or receptions, such as PSCCH transmission or reception or PSSCH transmission or reception. Without rules for prioritizing transmission of S-SSBs on second S-SSB occasions versus other communications overlapping with the second S-SSB occasions, sidelink synchronization may be negatively impacted and throughput may be decreased. Furthermore, in some examples, a second S-SSB transmission of one UE may overlap with an S-SSB transmission of another UE. Without rules for prioritizing transmission and reception of S-SSBs when a second S-SSB transmission overlaps with reception of another S-SSB, UEs may fail to efficiently synchronize on the sidelink, which may be particularly impactful when out of radio access network coverage.

Various aspects relate generally to prioritization of sidelink communications. Some aspects more specifically relate to prioritization between second S-SSB occasions and other communications in a sidelink resource pool. In some examples, the UE may receive a configuration indicating a first S-SSB occasion and a set of second S-SSB occasions (e.g., additional candidate S-SSB occasions). The UE may also receive priority information that indicates one or more transmission priorities for the set of second S-SSB occasions. The UE may perform a communication (which may include an S-SSB transmission on a second S-SSB occasion, or transmission or reception of another communication) in association with the set of second S-SSB occasions in accordance with the priority information. Thus, sidelink synchronization is improved and throughput is increased. In some examples, the UE may transmit an S-SSB on a second S-SSB occasion based at least in part on comparing a transmission priority of a received S-SSB and the transmission priority of the S-SSB on the second S-SSB occasion. For example, the transmission priority associated with the received S-SSB may be based at least in part on (or may be) a synchronization priority of the received S-SSB. Thus, efficiency of sidelink synchronization is improved, particularly when out of radio access network coverage.

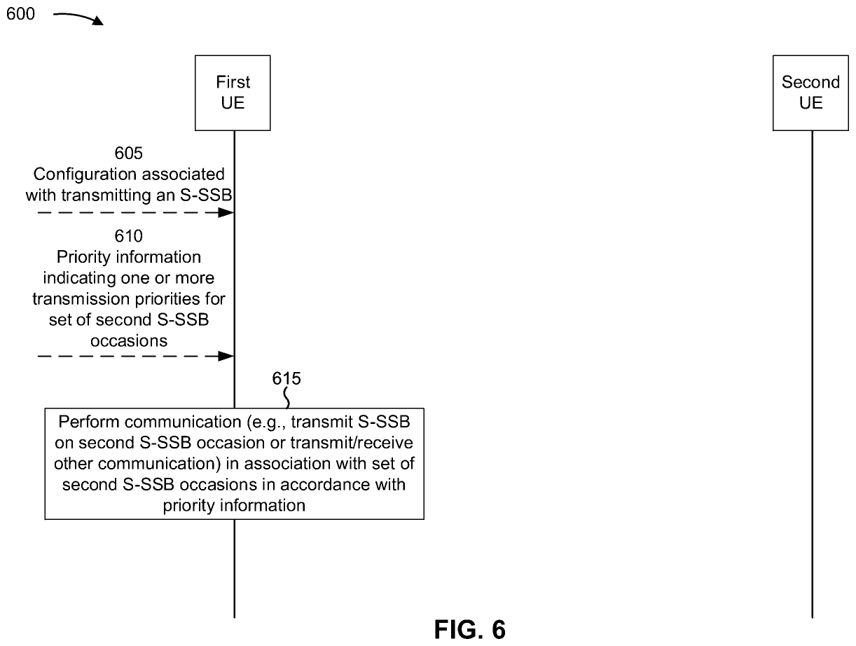

FIG. 6 is a diagram illustrating an example 600 of signaling associated with prioritization for sidelink synchronization signal blocks, in accordance with the present disclosure. Example 600 includes a first UE (e.g., UE 120, UE 405, UE 505, UE 510) and a second UE (e.g., UE 120, UE 405, UE 505, UE 510).

As shown by reference number 605, the first UE may receive (e.g., from a network node such as network node 110) a configuration associated with transmitting an S-SSB. For example, the configuration may include an RRC message, multiple RRC messages (e.g., two or more separate transmissions of RRC signaling), and/or another form of message (e.g., MAC signaling, DCI, or the like). In some aspects, the configuration may indicate a first S-SSB occasion. For example, the configuration may include a sidelink bandwidth part configuration that indicates the first S-SSB occasion (e.g., a sidelink S-SSB slot). In some aspects, the configuration may indicate a set of second S-SSB occasions. For example, the configuration may indicate one or more resources, other than the first S-SSB occasion, on which an S-SSB can be transmitted by the first UE, as described in more detail in connection with FIG. 4. The configuration may include, for example, a sidelink bandwidth part configuration, a sidelink resource pool configuration, or the like.

As shown by reference number 610, the first UE may receive (e.g., from a network node such as network node 110 or from the second UE) priority information indicating one or more transmission priorities for the set of second S-SSB occasions. In some aspects, the priority information may be included in or received in association with the configuration shown by reference number 605. A transmission priority may include a value that indicates a priority of a transmission. A lower transmission priority may correspond to a higher priority for transmission. For example, a transmission priority of “1” may lead to a given transmission being prioritized (e.g., transmitted or received) over transmissions having transmission priorities of “2” or greater.

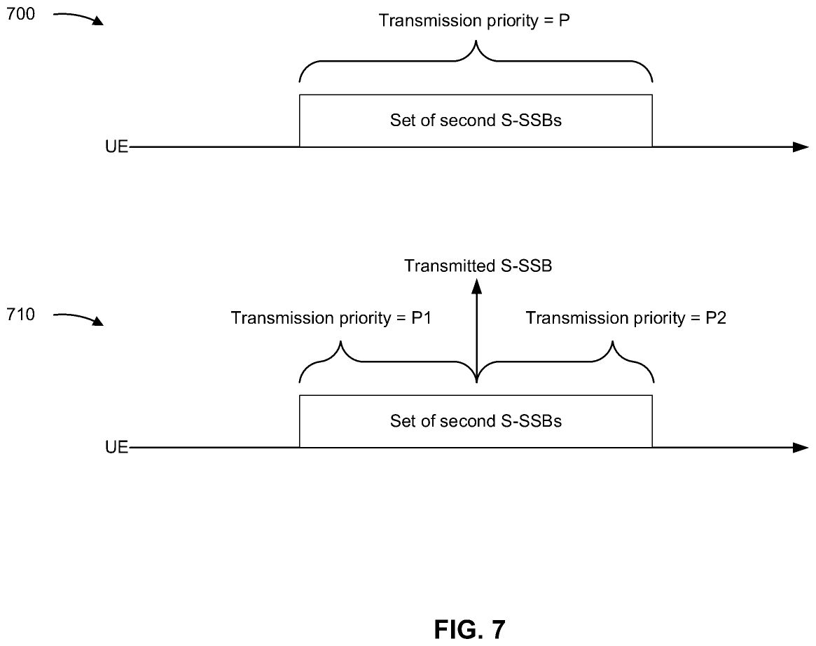

In some aspects, the priority information may indicate a single transmission priority for all of the set of second S-SSB occasions. For example, the priority information may indicate one transmission priority, configured via RRC signaling. In this example, the one transmission priority may apply to all second S-SSB occasions configured by the configuration, as shown by reference number 700 of FIG. 7. In some aspects, the transmission priority may be provided via a parameter that applies to a first S-SSB occasion, such as sl-SSB-PriorityNR. For example, the transmission priority of the second S-SSB occasions may be the same as the transmission priority for the first S-SSB occasion. This may reduce overhead relative to signaling separate transmission priorities for the first S-SSB occasion and a second S-SSB occasion. In some other aspects, the priority information may include a parameter specific to second S-SSB occasions. For example, the priority information may indicate one transmission priority that applies to the set of second S-SSB occasions, and another transmission priority may apply to the first S-SSB occasion. Providing a transmission priority specific to the second S-SSB occasions may increase flexibility of prioritization relative to a single transmission priority that applies to the first S-SSB occasion and the second S-SSB occasions.

In some aspects, the priority information may indicate multiple transmission priorities. For example, the priority information may indicate a first transmission priority and a second transmission priority. The first transmission priority may apply to the set of second S-SSB occasions before the S-SSB is transmitted on the set of second S-SSB occasions and the second transmission priority may apply to the set of second S-SSB occasions after the S-SSB is transmitted on the set of second S-SSB occasions, as shown by reference number 710 of FIG. 7. For example, if an S-SSB has not been transmitted in a given S-SSB period, the first transmission priority may apply, and if the S-SSB has been transmitted in the given S-SSB period, the second transmission priority may apply. In some aspects, the second transmission priority may be higher than the first transmission priority. In some other aspects, the second transmission priority may be lower than the first transmission priority. In some aspects, the priority information may explicitly indicate the first transmission priority and the second transmission priority (e.g., by including a first value that identifies the first transmission priority, such as “P1” and a second value that identifies the second transmission priority, such as “P2”). In some other aspects, the priority information may explicitly indicate the first transmission priority, and may indicate the second transmission priority using an offset relative to the first transmission priority (e.g., by including a first value that identifies the first transmission priority, such as “P1,” and an offset that indicates the second transmission priority relative to the first transmission priority, such as “+1”).

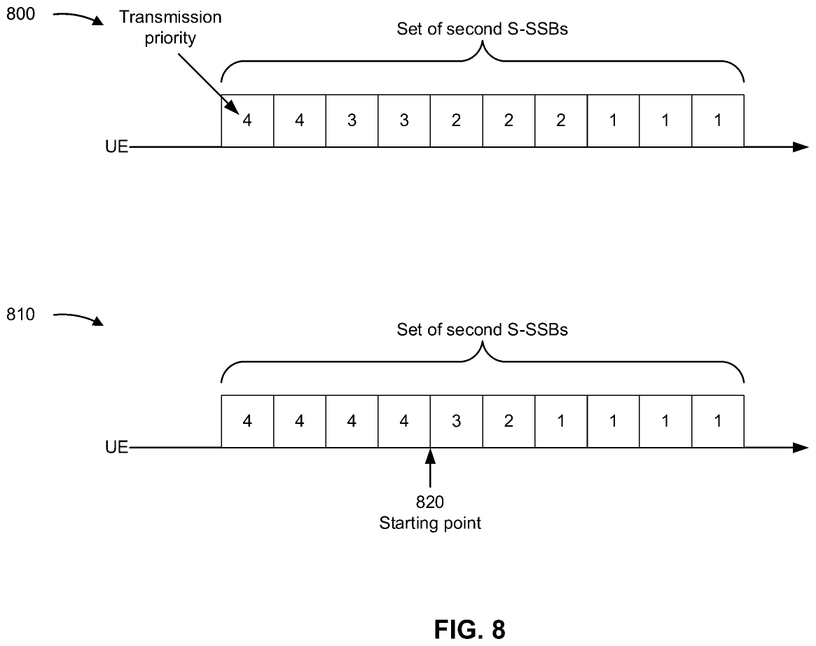

As another example, the priority information may indicate a respective transmission priority for each S-SSB occasion of a plurality of second S-SSB occasions. For example, the priority information may include a plurality of transmission priorities, each transmission priority corresponding to a different second S-SSB occasion. As another example, the priority information may indicate one or more transmission priorities corresponding to one or more second S-SSB occasions, and transmission priorities of a remainder of the second S-SSB occasions may be derived from the one or more transmission priorities according to a rule (which may be indicated by the priority information, or which may be defined in a wireless communication specification or a configuration of the first UE). In some aspects, the transmission priority may be based at least in part on whether an S-SSB has already been transmitted in an S-SSB period. For example, if an S-SSB has not been transmitted or received in an S-SSB period, a transmission priority of second S-SSB occasions in the S-SSB period may have a higher transmission priority (corresponding to a lower prioritization of the second S-SSB occasions) than if an S-SSB has been transmitted or received in the S-SSB period. Examples of transmission priorities for each S-SSB occasion of a plurality of second S-SSB occasions are shown by examples 800 and 810 of FIG. 8. In example 800, transmission priorities of second S-SSB occasions decrease in a substantially uniform fashion, such that a priority for transmission of an S-SSB increases in a substantially uniform fashion. In example 810, transmission priorities of a plurality of second S-SSB occasions decrease based at least in part on a starting point. For example, the plurality of second S-SSB occasions are associated with a starting point 820. Preceding second S-SSB occasions, of the plurality of second S-SSB occasions, that precede the starting point 820 have a first transmission priority (shown as “4”), and subsequent second S-SSB occasions, of the plurality of second S-SSB occasions, that occur after the starting point 820 have one or more second transmission priorities lower than the first transmission priority (since a lower transmission priority value may correspond to a higher priority for transmission). In example 810, the transmission priority of the subsequent second S-SSB occasions decreases by 1 per second S-SSB occasion until reaching a minimum value (e.g., “1”), such that the subsequent second S-SSB occasions are gradually assigned a higher priority for transmission.

As shown by reference number 615, the first UE may perform a communication in association with the set of second S-SSB occasions in accordance with the priority information. For example, the first UE may transmit an S-SSB on a second S-SSB occasion according to a comparison between the one or more transmission priorities associated with the second S-SSB occasion and a transmission priority associated with another sidelink transmission. As another example, the first UE may transmit or receive the other sidelink transmission according to the comparison. The other sidelink transmission may overlap, at least in part, with one or more second S-SSB occasions of the set of second S-SSB occasions.

In some aspects, the first UE may perform the communication based at least in part on an index of a second S-SSB occasion and a retransmission number index of a PSSCH communication. For example, the first UE may transmit an S-SSB on the second S-SSB occasion, or may transmit or receive a PSSCH communication on a resource that at least partially overlaps the second S-SSB occasion, based at least in part on the index and the retransmission number index. The retransmission number index may indicate a retransmission of the PSSCH communication. For example, “10” may indicate a tenth retransmission of the PSSCH communication (with indexing starting at 1). Retransmission of PSSCH communications may aid a receiving UE in decoding the PSSCH communication, for example, by facilitating combination of multiple PSSCH communications and by enabling maintenance of a COT. An index of a second S-SSB occasion may indicate a position of the second S-SSB occasion relative to other second S-SSB occasions. For example, an index of “0” may indicate an initial second S-SSB occasion, and an index of “1” may indicate a next second S-SSB occasion after the initial second S-SSB occasion.

In some aspects, the UE may compare the index of the second S-SSB occasion and the retransmission number index (or a value derived from the retransmission number index). For example, the UE may prioritize the transmission of the S-SSB if the S-SSB occasion index is larger than the PSSCH retransmission number index, and may otherwise prioritize the PSSCH communication.

In some aspects, the first UE may compare a first index derived from the index of the second S-SSB occasion, a second index derived from the retransmission number index, or a combination thereof. For example, the first UE may determine the first index by reference to a table. Additionally, or alternatively, the first UE may determine the second index by reference to a table. In some aspects, the first index may be normalized to the PSSCH retransmission number index. Additionally, or alternatively, the second index may be normalized to the S-SSB occasion index. Additionally, or alternatively, the first index and the second index may be normalized with one another such that the first index is selected from the same number of potential values as the second index. In some aspects, the first UE may determine the first index and the second index by reference to a table, such as Table 1, below:

TABLE 1

| First/second | S-SSB occasion | PSSCH retransmission |
|---|---|---|
| index | index | number index |
| 1 | 1 | 1, 2, 3 |
| 2 | 2 | 4, 5, 6 |
| . . . | . . . | . . . |
| 9 | 9 | 25, 26, 27 |
| 10 | 10 | 28, 29, 30 |

In the above example, the UE may identify a first index according to the “S-SSB occasion index” column of Table 1 and a second index according to the “PSSCH retransmission number index” column of Table 1. The UE may compare the first index and the second index. If the first index is larger than the second index, then the first UE may transmit an S-SSB on a second S-SSB occasion having the S-SSB occasion index. If the first index is not larger than the second index, then the first UE may transmit or receive the PSSCH communication.

As indicated above, FIGS. 6-8 are provided as examples. Other examples may differ from what is described with regard to FIGS. 6-8.

FIG. 9 is a diagram illustrating an example 900 of prioritization among S-SSB according to synchronization priorities, in accordance with the present disclosure. Example 900 includes a first UE (e.g., UE 120, UE 405, UE 505, UE 510, the UE of FIGS. 6-8) and a second UE (e.g., UE 120, UE 405, UE 505, UE 510, the UE of FIGS. 6-8). In example 900, the first UE may be configured with a first S-SSB occasion and one or more second S-SSB occasions, as described above with regard to reference number 605.

As shown by reference number 910, the second UE may transmit, and the first UE may receive, an S-SSB (referred to hereinafter as a received S-SSB). The received S-SSB may indicate a synchronization priority of the received S-SSB. In example 900, the synchronization priority of the received S-SSB may be used as a transmission priority for purposes of determining whether reception of a subsequent S-SSB from the second UE should be prioritized over transmission of an S-SSB on a second S-SSB occasion by the first UE.

As shown by reference number 920, the second UE may perform a communication based at least in part on comparing a transmission priority associated with the received S-SSB (e.g., the synchronization priority of the received S-SSB) and a transmission priority of a second S-SSB occasion (which may be a synchronization priority of the second S-SSB occasion).

In some aspects, the synchronization priority of the received S-SSB may increase with regard to an S-SSB occasion index of the second S-SSB occasion (e.g., as a remaining number of time resources of the plurality of second S-SSB occasions decreases). For example, the first UE may be associated with a plurality of second S-SSB occasions that have increasing S-SSB occasion indexes. The synchronization priority of the received S-SSB may increase with regard to the S-SSB occasion index. For example, at a first slot associated with a lower S-SSB occasion index, the first UE may identify a first (lower) synchronization priority of the received S-SSB, such that the first UE is more likely to determine to receive the received S-SSB (i.e., another S-SSB transmitted by the same UE as the received S-SSB) than to transmit the second S-SSB on the first slot. At a second slot associated with a higher S-SSB occasion index, the first UE may identify a second (higher) synchronization priority of the received S-SSB, such that the first UE is more likely to determine to transmit the second S-SSB on the second slot than to receive the received S-SSB on the first slot. Thus, the first UE may switch to a transmit mode and transmit a second S-SSB if the synchronization priority of the second S-SSB indicates to prioritize transmission of the second S-SSB over the received S-SSB, which may be more likely to occur as the first UE approaches an end of the plurality of second S-SSB occasions. This technique may be useful for re-synchronization or maintaining time/frequency synchronization with the second UE, while increasing the likelihood that the first UE transmits the second S-SSB on one of the plurality of second S-SSB occasions. For example, this may be useful when S-SSB slots of the first UE overlap with S-SSB slots of the second UE to reduce overhead.

In some aspects, the synchronization priority of the second S-SSB may decrease with regard to an S-SSB occasion index of the second S-SSB occasion (e.g., as a remaining number of time resources of the plurality of second S-SSB occasions decreases). For example, the first UE may be associated with a plurality of second S-SSB occasions that have increasing S-SSB occasion indexes. The synchronization priority of the second S-SSB may decrease with regard to the S-SSB occasion index. For example, at a first slot associated with a lower S-SSB occasion index, the first UE may identify a first (higher) synchronization priority of the second S-SSB, such that the first UE is more likely to determine to receive the received S-SSB (i.e., another S-SSB transmitted by the same UE as the received S-SSB) than to transmit the second S-SSB on the first slot. At a second slot associated with a higher S-SSB occasion index, the first UE may identify a second (lower) synchronization priority of the second S-SSB, such that the first UE is more likely to determine to transmit the second S-SSB on the second slot than to receive the received S-SSB on the first slot. Thus, the first UE may switch to a transmit mode and transmit a second S-SSB if the synchronization priority of the second S-SSB indicates to prioritize received S-SSB, which may be more likely to occur as the first UE approaches an end of the plurality of second S-SSB occasions. This technique may be useful for re-synchronization or maintaining time/frequency synchronization with the second UE, while increasing the likelihood that the first UE transmits the second S-SSB on one of the plurality of second S-SSB occasions.

As indicated above, FIG. 9 is provided as an example. Other examples may differ from what is described with regard to FIG. 9.

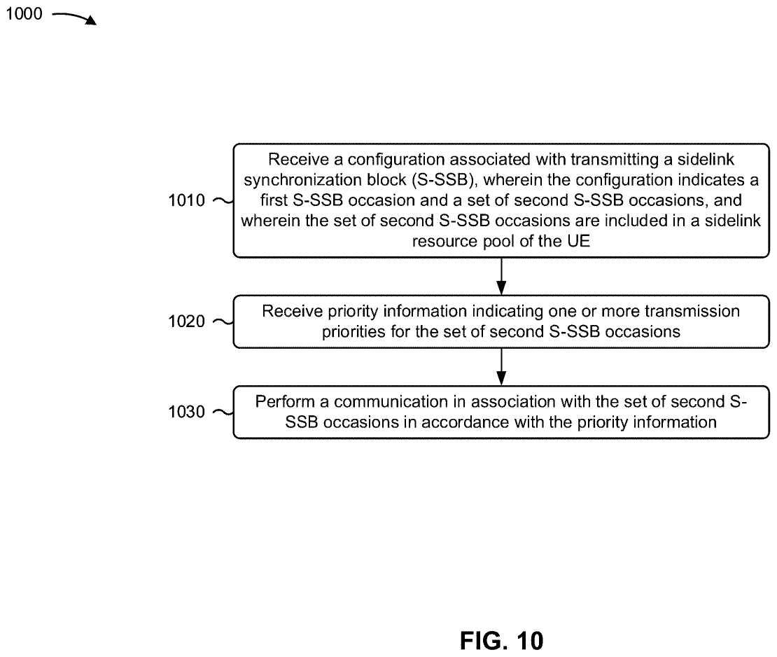

FIG. 10 is a diagram illustrating an example process 1000 performed, for example, by a UE, in accordance with the present disclosure. Example process 1000 is an example where the UE (e.g., UE 120, UE 405, UE 505, UE 510, the first UE of FIGS. 6-10) performs operations associated with techniques for prioritization for sidelink synchronization signal blocks.

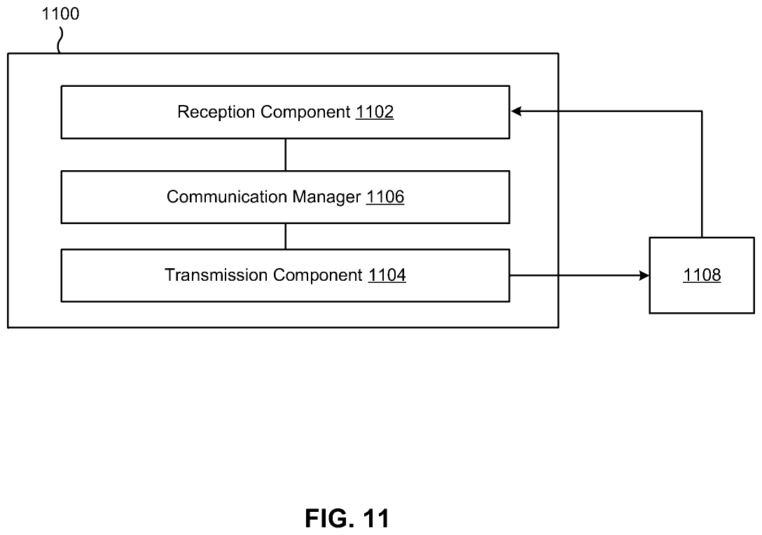

As shown in FIG. 10, in some aspects, process 1000 may include receiving a configuration associated with transmitting an S-SSB, wherein the configuration indicates a first S-SSB occasion and a set of second S-SSB occasions, and wherein the set of second S-SSB occasions are included in a sidelink resource pool of the UE (block 1010). For example, the UE (e.g., using reception component 1102 and/or communication manager 1106, depicted in FIG. 11) may receive a configuration associated with transmitting an S-SSB, wherein the configuration indicates a first S-SSB occasion and a set of second S-SSB occasions, and wherein the set of second S-SSB occasions are included in a sidelink resource pool of the UE, as described above.

As further shown in FIG. 10, in some aspects, process 1000 may include receiving priority information indicating one or more transmission priorities for the set of second S-SSB occasions (block 1020). For example, the UE (e.g., using reception component 1102 and/or communication manager 1106, depicted in FIG. 11) may receive priority information indicating one or more transmission priorities for the set of second S-SSB occasions, as described above.

As further shown in FIG. 10, in some aspects, process 1000 may include performing a communication in association with the set of second S-SSB occasions in accordance with the priority information (block 1030). For example, the UE (e.g., using communication manager 1106, depicted in FIG. 11) may perform a communication in association with the set of second S-SSB occasions in accordance with the priority information, as described above.

Process 1000 may include additional aspects, such as any single aspect or any combination of aspects described below and/or in connection with one or more other processes described elsewhere herein.

In a first aspect, performing the communication further comprises transmitting the S-SSB on the set of second S-SSB occasions in accordance with the priority information.

In a second aspect, alone or in combination with the first aspect, performing the communication further comprises transmitting or receiving a sidelink transmission on the set of second S-SSB occasions in accordance with a transmission priority of the sidelink transmission and the priority information.

In a third aspect, alone or in combination with one or more of the first and second aspects, the priority information indicates a single priority value for all of the set of second S-SSB occasions.

In a fourth aspect, alone or in combination with one or more of the first through third aspects, the single priority value applies to the first S-SSB occasion and the set of second S-SSB occasions.

In a fifth aspect, alone or in combination with one or more of the first through fourth aspects, the single priority value is a first priority value, and the first S-SSB occasion is associated with a second priority value different from the first priority value.

In a sixth aspect, alone or in combination with one or more of the first through fifth aspects, the priority information indicates a first priority value and a second priority value, wherein the first priority value applies to the set of second S-SSB occasions before the S-SSB is transmitted on the set of second S-SSB occasions and the second priority value applies to the set of second S-SSB occasions after the S-SSB is transmitted on the set of second S-SSB occasions.

In a seventh aspect, alone or in combination with one or more of the first through sixth aspects, the priority information explicitly identifies the first priority value and the second priority value.

In an eighth aspect, alone or in combination with one or more of the first through seventh aspects, the priority information indicates the second priority value using an offset relative to the first priority value.

In a ninth aspect, alone or in combination with one or more of the first through eighth aspects, the set of second S-SSB occasions includes a plurality of second S-SSB occasions, and the priority information indicates a respective transmission priority for each second S-SSB occasion of the plurality of second S-SSB occasions.

In a tenth aspect, alone or in combination with one or more of the first through ninth aspects, a transmission priority of a later S-SSB occasion of the plurality of second S-SSB occasions is based at least in part on a transmission priority of an earlier S-SSB occasion of the plurality of second S-SSB occasions.

In an eleventh aspect, alone or in combination with one or more of the first through tenth aspects, the transmission priority of the later S-SSB occasion of the plurality of second S-SSB occasions is lower than the transmission priority of the earlier S-SSB occasion of the plurality of second S-SSB occasions.

In a twelfth aspect, alone or in combination with one or more of the first through eleventh aspects, the plurality of second S-SSB occasions are associated with a starting point, wherein preceding second S-SSB occasions, of the plurality of second S-SSB occasions, that precede the starting point have a first transmission priority, and wherein subsequent second S-SSB occasions, of the plurality of second S-SSB occasions, that occur after the starting point have one or more second transmission priorities lower than the first transmission priority.

In a thirteenth aspect, alone or in combination with one or more of the first through twelfth aspects, the one or more second transmission priorities decrease as a function of time relative to the starting point.

In a fourteenth aspect, alone or in combination with one or more of the first through thirteenth aspects, performing the communication in association with the set of second S-SSB occasions in accordance with the priority information further comprises transmitting the S-SSB, or transmitting or receiving a physical sidelink shared channel communication, based at least in part on an index of a second S-SSB occasion of the set of second S-SSB occasions and a retransmission number index of the physical sidelink shared channel communication.

In a fifteenth aspect, alone or in combination with one or more of the first through fourteenth aspects, transmitting the S-SSB or transmitting or receiving the physical sidelink shared channel communication further comprises transmitting the S-SSB based at least in part on the index of the second S-SSB occasion being larger than the retransmission number index.

In a sixteenth aspect, alone or in combination with one or more of the first through fifteenth aspects, transmitting the S-SSB or transmitting or receiving the physical sidelink shared channel communication further comprises transmitting the S-SSB or transmitting or receiving the physical sidelink shared channel communication based at least in part on at least one of a first index derived from the index of the second S-SSB occasion or a second index derived from the retransmission number index.

In a seventeenth aspect, alone or in combination with one or more of the first through sixteenth aspects, performing the communication in association with the set of second S-SSB occasions in accordance with the priority information further comprises transmitting the S-SSB based at least in part on comparing a transmission priority associated with a second S-SSB from a second UE and the one or more transmission priorities.

In an eighteenth aspect, alone or in combination with one or more of the first through seventeenth aspects, the transmission priority associated with the second S-SSB decreases as a function of a remaining number of time resources of the set of second S-SSB occasions.

In a nineteenth aspect, alone or in combination with one or more of the first through eighteenth aspects, the transmission priority associated with the second S-SSB is based at least in part on a synchronization priority of the second S-SSB.

In a twentieth aspect, alone or in combination with one or more of the first through nineteenth aspects, the one or more transmission priorities increase as a function of a remaining number of time resources of the set of second S-SSB occasions.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4-8. Additionally, or alternatively, the apparatus 1100 may be configured to perform one or more processes described herein, such as process 1000 of FIG. 10, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a configuration associated with transmitting an S-SSB, wherein the configuration indicates a first S-SSB occasion and a set of second S-SSB occasions, and wherein the set of second S-SSB occasions are included in a sidelink resource pool of the UE. The reception component 1102 may receive priority information indicating one or more transmission priorities for the set of second S-SSB occasions. The communication manager 1106 may perform a communication in association with the set of second S-SSB occasions in accordance with the priority information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving a configuration associated with transmitting a sidelink synchronization signal block (S-SSB), wherein the configuration indicates a first S-SSB occasion and a set of second S-SSB occasions, and wherein the set of second S-SSB occasions are included in a sidelink resource pool of the UE; receiving priority information indicating one or more transmission priorities for the set of second S-SSB occasions; and performing a communication in association with the set of second S-SSB occasions in accordance with the priority information.

Aspect 2: The method of Aspect 1, wherein performing the communication further comprises transmitting the S-SSB on the set of second S-SSB occasions in accordance with the priority information.

Aspect 3: The method of any of Aspects 1-2, wherein performing the communication further comprises transmitting or receiving a sidelink transmission on the set of second S-SSB occasions in accordance with a transmission priority of the sidelink transmission and the priority information.

Aspect 4: The method of any of Aspects 1-3, wherein the priority information indicates a single priority value for all of the set of second S-SSB occasions.

Aspect 5: The method of Aspect 4, wherein the single priority value applies to the first S-SSB occasion and the set of second S-SSB occasions.

Aspect 6: The method of Aspect 4, wherein the single priority value is a first priority value and wherein the first S-SSB occasion is associated with a second priority value different from the first priority value.

Aspect 7: The method of any of Aspects 1-6, wherein the priority information indicates a first priority value and a second priority value, wherein the first priority value applies to the set of second S-SSB occasions before the S-SSB is transmitted on the set of second S-SSB occasions and the second priority value applies to the set of second S-SSB occasions after the S-SSB is transmitted on the set of second S-SSB occasions.

Aspect 8: The method of Aspect 7, wherein the priority information explicitly identifies the first priority value and the second priority value.

Aspect 9: The method of Aspect 7, wherein the priority information indicates the second priority value using an offset relative to the first priority value.

Aspect 10: The method of any of Aspects 1-9, wherein the set of second S-SSB occasions include a plurality of second S-SSB occasions, and wherein the priority information indicates a respective transmission priority for each second S-SSB occasion of the plurality of second S-SSB occasions.

Aspect 11: The method of Aspect 10, wherein a transmission priority of a later S-SSB occasion of the plurality of second S-SSB occasions is based at least in part on a transmission priority of an earlier S-SSB occasion of the plurality of second S-SSB occasions.

Aspect 12: The method of Aspect 11, wherein the transmission priority of the later S-SSB occasion of the plurality of second S-SSB occasions is lower than the transmission priority of the earlier S-SSB occasion of the plurality of second S-SSB occasions.

Aspect 13: The method of Aspect 10, wherein the plurality of second S-SSB occasions are associated with a starting point, wherein preceding second S-SSB occasions, of the plurality of second S-SSB occasions, that precede the starting point have a first transmission priority, and wherein subsequent second S-SSB occasions, of the plurality of second S-SSB occasions, that occur after the starting point have one or more second transmission priorities lower than the first transmission priority.

Aspect 14: The method of Aspect 13, wherein the one or more second transmission priorities decrease as a function of time relative to the starting point.

Aspect 15: The method of any of Aspects 1-14, wherein performing the communication in association with the set of second S-SSB occasions in accordance with the priority information further comprises transmitting the S-SSB, or transmitting or receiving a physical sidelink shared channel communication, based at least in part on an index of a second S-SSB occasion of the set of second S-SSB occasions and a retransmission number index of the physical sidelink shared channel communication.

Aspect 16: The method of Aspect 15, wherein transmitting the S-SSB or transmitting or receiving the physical sidelink shared channel communication further comprises transmitting the S-SSB based at least in part on the index of the second S-SSB occasion being larger than the retransmission number index.

Aspect 17: The method of Aspect 15, wherein transmitting the S-SSB or transmitting or receiving the physical sidelink shared channel communication further comprises transmitting the S-SSB or transmitting or receiving the physical sidelink shared channel communication based at least in part on at least one of a first index derived from the index of the second S-SSB occasion or a second index derived from the retransmission number index.

Aspect 18: The method of any of Aspects 1-17, wherein performing the communication in association with the set of second S-SSB occasions in accordance with the priority information further comprises transmitting the S-SSB based at least in part on comparing a synchronization priority associated with a second S-SSB from a second UE and a synchronization priority of the S-SSB. For example, the one or more transmission priorities may include the synchronization priority. In other words, the synchronization priority may be used as a transmission priority to prioritize transmission of the S-SSB or the second S-SSB.

Aspect 19: The method of Aspect 18, wherein the synchronization priority associated with the second S-SSB increases as a function of a remaining number of time resources of the set of second S-SSB occasions.

Aspect 20: The method of Aspect 18, wherein the transmission priority associated with the second S-SSB is based at least in part on a synchronization priority of the second S-SSB.

Aspect 21: The method of Aspect 18, wherein the one or more transmission priorities increase as a function of a remaining number of time resources of the set of second S-SSB occasions.

Aspect 22: An apparatus for wireless communication at a device, comprising a processor; memory coupled with the processor; and instructions stored in the memory and executable by the processor to cause the apparatus to perform the method of one or more of Aspects 1-21.

Aspect 23: A device for wireless communication, comprising a memory and one or more processors coupled to the memory, the one or more processors configured to perform the method of one or more of Aspects 1-21.

Aspect 24: An apparatus for wireless communication, comprising at least one means for performing the method of one or more of Aspects 1-21.

Aspect 25: A non-transitory computer-readable medium storing code for wireless communication, the code comprising instructions executable by a processor to perform the method of one or more of Aspects 1-21.

Aspect 26: A non-transitory computer-readable medium storing a set of instructions for wireless communication, the set of instructions comprising one or more instructions that, when executed by one or more processors of a device, cause the device to perform the method of one or more of Aspects 1-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

1. A user equipment (UE) for wireless communication, comprising:
one or more memories; and
one or more processors, coupled to the one or more memories, configured to:
receive a configuration associated with transmitting a sidelink synchronization signal block (S-SSB), wherein the configuration indicates a first S-SSB occasion and a set of second S-SSB occasions, and wherein the set of second S-SSB occasions are included in a sidelink resource pool of the UE;
receive priority information indicating one or more transmission priorities for the set of second S-SSB occasions; and
perform a communication in association with the set of second S-SSB occasions in accordance with the priority information.

2. The UE of claim 1, wherein the one or more processors, to perform the communication, are configured to transmit the S-SSB on the set of second S-SSB occasions in accordance with the priority information.

3. The UE of claim 1, wherein the one or more processors, to perform the communication, are configured to transmit or receive a sidelink transmission on the set of second S-SSB occasions in accordance with a transmission priority of the sidelink transmission and the priority information.

4. The UE of claim 1, wherein the priority information indicates a single priority value for all of the set of second S-SSB occasions.

5. The UE of claim 4, wherein the single priority value applies to the first S-SSB occasion and the set of second S-SSB occasions.

6. The UE of claim 4, wherein the single priority value is a first priority value and wherein the first S-SSB occasion is associated with a second priority value different from the first priority value.

7. The UE of claim 1, wherein the priority information indicates a first priority value and a second priority value, wherein the first priority value applies to the set of second S-SSB occasions before the S-SSB is transmitted on the set of second S-SSB occasions and the second priority value applies to the set of second S-SSB occasions after the S-SSB is transmitted on the set of second S-SSB occasions.

8. The UE of claim 7, wherein the priority information explicitly identifies the first priority value and the second priority value.

9. The UE of claim 7, wherein the priority information indicates the second priority value using an offset relative to the first priority value.

10. The UE of claim 1, wherein the set of second S-SSB occasions include a plurality of second S-SSB occasions, and wherein the priority information indicates a respective transmission priority for each second S-SSB occasion of the plurality of second S-SSB occasions.

11. The UE of claim 10, wherein a transmission priority of a later S-SSB occasion of the plurality of second S-SSB occasions is based at least in part on a transmission priority of an earlier S-SSB occasion of the plurality of second S-SSB occasions.

12. The UE of claim 11, wherein the transmission priority of the later S-SSB occasion of the plurality of second S-SSB occasions is lower than the transmission priority of the earlier S-SSB occasion of the plurality of second S-SSB occasions.

13. The UE of claim 10, wherein the plurality of second S-SSB occasions are associated with a starting point, wherein preceding second S-SSB occasions, of the plurality of second S-SSB occasions, that precede the starting point have a first transmission priority, and wherein subsequent second S-SSB occasions, of the plurality of second S-SSB occasions, that occur after the starting point have one or more second transmission priorities lower than the first transmission priority.

14. The UE of claim 13, wherein the one or more second transmission priorities decrease as a function of time relative to the starting point.

15. The UE of claim 1, wherein the one or more processors, to perform the communication in association with the set of second S-SSB occasions in accordance with the priority information, are configured to transmit the S-SSB, or transmit or receiving a physical sidelink shared channel communication, based at least in part on an index of a second S-SSB occasion of the set of second S-SSB occasions and a retransmission number index of the physical sidelink shared channel communication.

16. The UE of claim 15, wherein the one or more processors, to transmit the S-SSB or transmit or receive the physical sidelink shared channel communication, are configured to transmit the S-SSB based at least in part on the index of the second S-SSB occasion being larger than the retransmission number index.

17. The UE of claim 15, wherein the one or more processors, to transmit the S-SSB or transmit or receive the physical sidelink shared channel communication, are configured to transmit the S-SSB or transmit or receive the physical sidelink shared channel communication based at least in part on at least one of a first index derived from the index of the second S-SSB occasion or a second index derived from the retransmission number index.

18.-21. (canceled)

22. A method of wireless communication performed by a user equipment (UE), comprising:
receiving a configuration associated with transmitting a sidelink synchronization signal block (S-SSB), wherein the configuration indicates a first S-SSB occasion and a set of second S-SSB occasions, and wherein the set of second S-SSB occasions are included in a sidelink resource pool of the UE;
receiving priority information indicating one or more transmission priorities for the set of second S-SSB occasions; and
performing a communication in association with the set of second S-SSB occasions in accordance with the priority information.

23. The method of claim 22, wherein the performance of the communication further comprises transmitting the S-SSB on the set of second S-SSB occasions in accordance with the priority information.

24. The method of claim 22, wherein the performance of the communication further comprises transmitting or receiving a sidelink transmission on the set of second S-SSB occasions in accordance with a transmission priority of the sidelink transmission and the priority information.

25.-30. (canceled)
